(19) United States
(12) Patent Application Publication
(10) Pub. No.: US 2025/0315633 A1
(43) Pub. Date: Oct. 9, 2025

(54) INDOOR ASSET TRACKING

(71) Applicant: Conexus, Inc., Murray, UT (US)

(72) Inventors: Benjamin Niklas Fuller, Logan, UT (US); Hyrum David Cooper, Logan, UT (US); Laker Bradley Dunford, Salt Lake City, UT (US); Colby Dunford Su, Sandy, UT (US)

(21) Appl. No.: 19/173,398

(22) Filed: Apr. 8, 2025

Related U.S. Application Data
(60) Provisional application No. 63/631,223, filed on Apr. 8, 2024.

(51) Int. Cl. G06K 7/10

(52) U.S. Cl. CPC G06K 7/10297

(57) ABSTRACT

Systems and methods for tracking a location of an asset within a facility. One system includes an electronic processor configured to receive active tracking information from a first communications device, the active tracking information corresponding to a first communications modality, receive passive tracking information from a second communications device, the passive tracking information corresponding to a second communications modality, determine, based on either or both of the passive tracking information and the active tracking information, a location of the asset within a predefined site survey, and generate, on a display, an indication of the determined location of the asset.

### RELATED APPLICATIONS

This application claims priority to U.S. Provisional Application No. 63/631,223, filed Apr. 8, 2024, the entire content of which is herein incorporated by reference.

### BACKGROUND

The systems and methods described herein relate to asset tracking within a facility.

### SUMMARY

An asset management system may be utilized to track and locate assets within a facility (for example, of an enterprise). Such systems may include one or more of a location engine for translating raw data from input devices into actionable insights about asset locations within defined spaces.

Existing location engines may utilize either of an active tracking system (for example, real-time location system (RTLS) or a passive tracking system (for example, radio frequency identification (RFID) based tracking system). However, such systems may have several challenges. For example, RTLS- and RFID-based systems may each produce inaccurate location information due to measurement errors in various data capturing methods. Each modality of tracking, like RFID or RTLS, enables the measurement of physical signal quantities (for example, received signal strength indicator (RSSI), phase angle, or time difference of arrival), each of which may be subject to some level of measurement error or error from interference factors in the working area. Location inaccuracy may then manifest in the form of a location-or a floor-level “bounce,” where the asset management system presents tracking to the user for the wrong location or floor.

Another challenge with asset-tracking systems may be security. Asset-tracking systems may have a significant network footprint which may introduce security implications. Existing solutions may not reach a security level required for some certain enterprises (for example, government and/or private contractors).

Such location engines may also be limited in their ability to be integrated into different asset management systems. For example, while many location engines may provide integration with multiple RTLS devices or RFID-based devices, they may not provide for simultaneous integration of a system including devices of both technologies.

Additionally, location engines may be required to scale with the number of assets, the number of distinct locations at which the assets may be tracked, or both. Location engines may have hard limits imposed on the number of trackable assets and/or locations that can be supported.

Thus, it may be desirable to have a location engine that addresses each of these challenges individually and that additionally anticipates future requirements so that enterprises can continue to provide efficient, secure, and reliable asset tracking without being as limited by technological constraints as described above.

Accordingly, in various implementations, the systems and methods described in this disclosure provide an asset tracking system including a location engine for tracking assets within a facility.

Other aspects of the disclosure will become apparent by consideration of the detailed description and accompanying drawings.

### BRIEF DESCRIPTION OF THE DRAWINGS

The accompanying figures, where like reference numerals refer to identical or functionally similar elements throughout the separate views, together with the detailed description below are incorporated in and form part of the specification and serve to further illustrate various embodiments of concepts that include the claimed invention, and to explain various principles and advantages of those embodiments.

FIG. 1 is an asset tracking system in accordance with some embodiments.

FIG. 2 is a block diagram of an electronic controller of the asset tracking system of FIG. 1 in accordance with some embodiments.

FIG. 3A is a block diagram of an active tracking communications device of the asset tracking system of FIG. 1 in accordance with some embodiments.

FIG. 3B is a block diagram of a passive tracking communications device of the asset tracking system of FIG. 1 in accordance with some embodiments.

FIG. 4 is a diagram illustrating a location engine of the electronic controller of FIG. 2 in accordance with some embodiments.

FIG. 5 is a diagram of a prediction pipeline of the location engine of FIG. 4 in accordance with some embodiments.

FIG. 6 illustrates an example of an encoding for an active tracking beacon in accordance with some embodiments.

FIG. 7 illustrates an example of a scalogram in accordance with some embodiments.

FIG. 8 is a block diagram illustrating the model training service of the asset tracking system of FIG. 1 in accordance with some embodiments.

FIG. 9 illustrates an example of a model architecture in accordance with some embodiments.

FIG. 10 is a graphical user interface (GUI) implemented by the electronic controller 102 of FIG. 2, in accordance with some embodiments.

FIG. 11 is a GUI implemented by the electronic controller 102 of FIG. 2, in accordance with some embodiments.

FIG. 12 is a GUI implemented by the electronic controller 102 of FIG. 2, in accordance with some embodiments.

FIG. 13 is a GUI implemented by the electronic controller 102 of FIG. 2, in accordance with some embodiments.

FIG. 14 is a flowchart illustrating a method for tracking an asset as implemented by the electronic controller of FIG. 2, in accordance with some embodiments.

FIG. 15 illustrates a site of a facility including the asset tracking system of FIG. 1 in accordance with some embodiments.

FIG. 16 illustrates a plurality of overlapping zones defined for a site in accordance with some embodiments.

FIG. 17 illustrates a plurality of zones defined for a site in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples, aspects, and features illustrated.

In some instances, the apparatus and method components have been represented where appropriate by conventional symbols in the drawings, showing only those specific details that are pertinent to understanding the of various embodiments, examples, aspects, and features so as not to obscure the disclosure with details that will be readily apparent to those of ordinary skill in the art having the benefit of the description herein.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. For example, it should be understood that although the systems herein depict components as logically separate, such depictions are merely for illustrative purposes. In some embodiments, the illustrated components may be combined or divided into separate software, firmware and/or hardware. These components may be executed on the same computing device or may be distributed among different computing devices connected by one or more networks or other suitable communication connections.

For ease of description, some or all of the example systems presented herein are illustrated with a single exemplar of each of its component parts. Some examples may not describe or illustrate all components of the systems. Other example embodiments may include more or fewer of each of the illustrated components, may combine some components, or may include additional or alternative components.

It should also be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

As used herein, the term “asset” refers to any kind of physical good capable of being moved from one location to another (for example, a commercial, consumer, or industrial product). The term “facility” used herein refers to any kind of building infrastructure (for example, a warehouse, an office building, a hospital, a retail store, a grocery store, a supercenter, and the like).

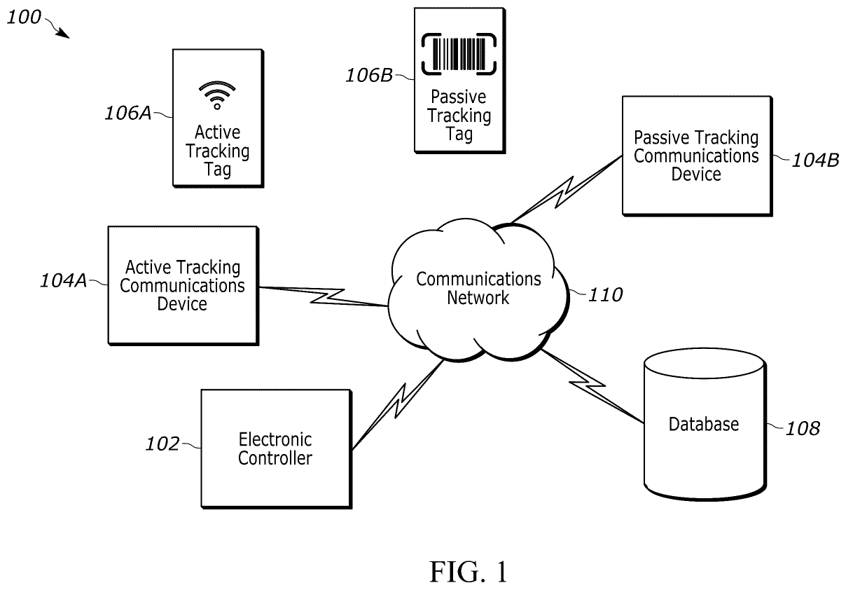

FIG. 1 illustrates an asset tracking system 100 for tracking a location of an asset within a facility in accordance with some embodiments. The system 100 includes an electronic controller 102, an active tracking communications device 104A, and a passive tracking communications device 104B. The active tracking communications device 104A receives information from one or more of an active tracking tag 106A within the facility according to a first communications modality. The passive tracking communications device 104 detects and gathers information from one or more of a passive tracking tag 106B within the facility according to a second communications modality. In the illustrated embodiment, the first communications modality is a local area network modality for RTLS such as Wi-Fi™ or Bluetooth and the second communications modality is a passive tracking communications modality such as RFID. In some embodiments, the system 100 further includes a database 108.

The electronic controller 102, the active tracking communications device 104A, the passive tracking communications device 104B, and the optional database 108 are communicatively coupled to each other via a communications network 110. The communications network 110 may be implemented using wired or wireless communication components and may include various networks, for example, a wide area network, such as the Internet, a local area network (for example a Wi-Fi™ network), and combinations or derivatives thereof.

For ease of description, the system 100 is described herein in terms of a singular active communications device 104A and a singular passive tracking communications device 104B in terms of a singular active tracking tag 106A and a singular passive tracking tag 106B. It should be understood that, in some embodiments, the system 100 includes more than one of the active communications device 104A, the passive tracking communications device 104B, or both, each of which respectively communicates with one or more of an active tracking tag 106A and a passive tracking tag 106B.

The active tracking communications device 104A and the passive tracking communications device 104B are both disposed within the facility. As mentioned above, each of the active tracking communications device 104A and the passive tracking communications device 104B collect respective information from at least one active tracking tag 106A and at least one passive tracking tag 106B. The active tracking tag 106A is an electronic device configured to actively, periodically broadcast, according to the first communications modality, information unique to the particular active tracking tag 106A. The active tracking tag 106A may be, for example, a wireless communications fob (for example, a Wi-Fi™ tag). The passive tracking tag 106B is a passive RFID tag configured to be read via an RFID scan performed by the passive tracking communications device 104B according to the second communications modality. The passive tracking tag 106B may be, for example, an RFID tag. The RFID scan may be performed automatically by the passive tracking communications device 104B (for example, periodically at a predetermined frequency), manually by a user, or some combination thereof.

The active tracking tag 106A is positioned on (for example, physically attached, coupled, or integrated into) a respective asset (not shown). The passive tracking tag 106B is also positioned on (for example, physically attached, coupled to, or integrated into) a respective asset. In some embodiments, both the active tracking tag 106A and the passive tracking tag 106B are positioned on a common asset. As explained in more detail below, the information received from the tag 106A and the tag 106B each include a unique identifier and a received communications signal strength. The information may additionally include a timestamp indicating a receipt time of the information at the respective communications device 104A, 104B.

Either or both of the active tracking tag 106A and the passive tracking tag 106B may be associated with a particular asset of the facility. For example, the information collected from the tag 106A and/or 106B may include a unique identifier associated with the particular asset (for example, a serial number). Both tags 106A and 106B may be associated with a same asset or different assets. In some embodiments, the information from either or both of the tags 106A, 106B may include product information related to the particular asset. The product information may include, for example, a serial number, a primary manufacturer, a secondary manufacturer, a handling history, and the like.

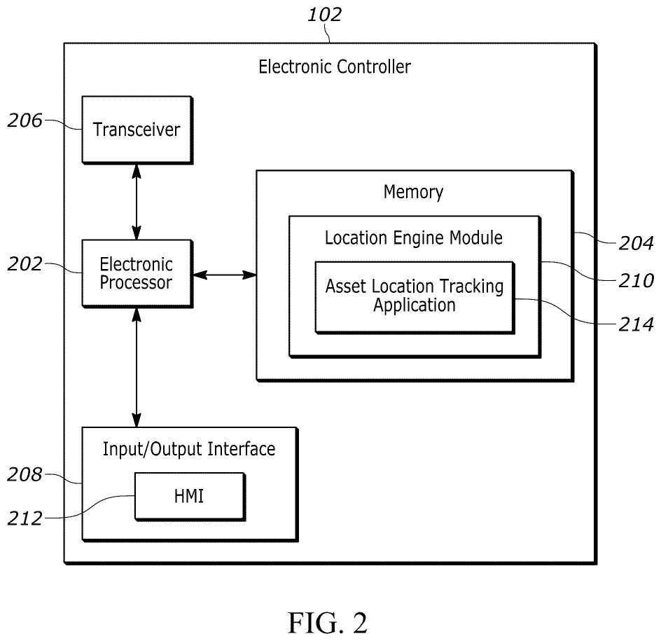

The electronic controller 102, explained in more detail below with respect to FIG. 2, is configured to receive the information collected from the one or more active tracking tags 106A and the one or more passive tracking tags 106B. As also explained in more detail below, the electronic controller 102 is configured to determine a location of an asset within the facility based on the information from the active tracking tag 106A, the passive tracking tag 106B, or both. In some embodiments, the electronic controller 102 is a physical or cloud-based management server within or remote from the facility that tracks the assets of the facility.

In some embodiments, to implement the methods described herein, the electronic controller 102 may communicate with the database 108. The database 108 may be a database housed on a suitable database server communicatively coupled to and accessible by the electronic controller 102. In alternative embodiments, the database 108 is part of a cloud-based database system external to the system 100 and accessible by the electronic controller 102 over one or more networks. Also, in some embodiments, all or part of the database 108 is locally stored on the electronic controller 102 (for example, within the memory 204 of FIG. 2). For example, in some embodiments, the electronic controller 102 stores information regarding the location of a particular asset within the database 108. In some embodiments, the database 108 is a database server remote from the controller 102. In some embodiments, some or all functionality of the database 108 described herein is alternatively integrated into the electronic controller 102.

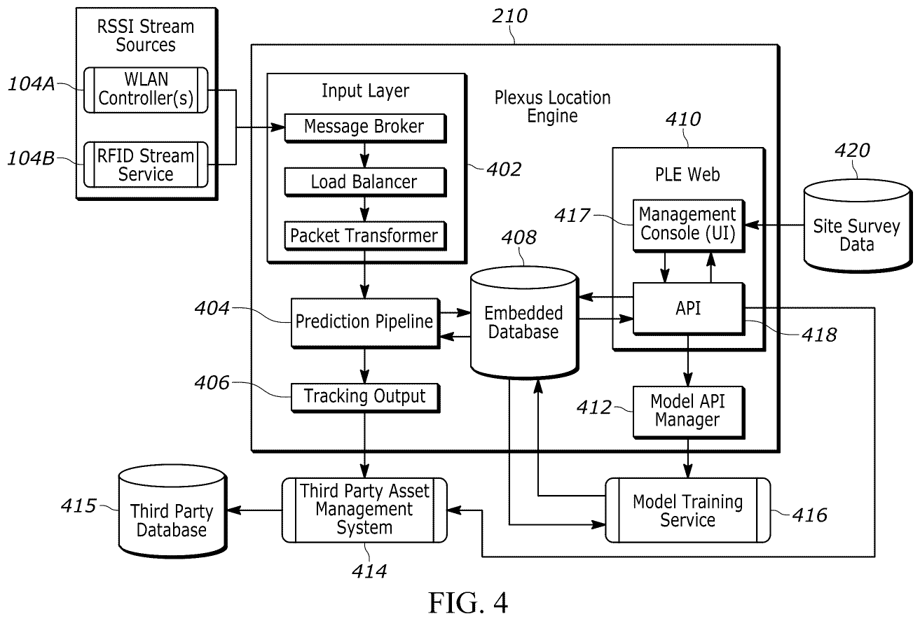

Referring to FIG. 2, the electronic controller 102 includes an electronic processor 202, a memory 204, a transceiver 206, and an input/output interface 208 communicating over one or more control and/or data buses. The electronic controller 102 also includes, within the memory 204, a location engine module 210 (described in more detail below with respect to FIG. 4). The electronic processor 202, in coordination with the memory 204, is configured to implement, among other things, the methods described herein. It should be understood that some or all of the components, including additional components, of the controller 102 may be remote/dispersed from each other within and/or outside of the facility.

In some embodiments, the electronic processor 202 is implemented as a microprocessor with separate memory, such as the memory 204. In other embodiments, the electronic processor 202 may be implemented as a microcontroller (with the memory 204 on the same chip). In other embodiments, the electronic processor 202 may be implemented using multiple processors. In addition, the electronic processor 202 may be implemented partially or entirely as, for example, a field-programmable gate array (FPGA), an application specific integrated circuit (ASIC), and the like and the memory 204 may not be needed or be modified accordingly.

In some embodiments, the electronic controller 102 may include one electronic processor 202 and/or a plurality of electronic processors 202 in a cloud computer cluster arrangement, one or more of which may be executing none, all, or a portion of the applications of the electronic controller 102 provided below, sequentially or in parallel across the one or more electronic processors 202. The one or more electronic processors 202 of the electronic controller 102 may be geographically co-located or may be separated by inches, meters, kilometers, or miles, and interconnected via electronic and/or optical interconnects. One or more proxy servers or load balancing servers may control which one or more electronic processors 202 perform any part or all the applications provided below in such embodiments.

In the example illustrated, the memory 204 includes non-transitory, computer-readable memory that stores instructions that are received and executed by the electronic processor 202 to carry out the functionality of the electronic controller 102 described herein. The memory 204 may include, for example, a program storage area and a data storage area (not shown). The program storage area and the data storage area may include combinations of different types of memory, such as read-only memory (ROM) and random-access memory (RAM). The electronic processor 202, in coordination with the memory 204, is configured to implement, among other things, the methods described herein.

The transceiver 206 enables wired and/or wireless communication between the electronic controller 102 and the active tracking communications device 104A, the passive tracking communications device 104B, and the optional database 108 over the communication network 110. In some embodiments, the transceiver 206 may comprise separate transmitting and receiving components, for example, a transmitter and a receiver.

The input/output interface 208 may include one or more input mechanisms (for example, a touch pad, a keypad, and the like), one or more output mechanisms (for example, a display, a speaker, and the like), or a combination thereof, or a combined input and output mechanism such as a touch screen. For example, in the illustrated embodiment, the input/output interface 208 includes a human machine interface (HMI) 212. The HMI 212 provides visual output, such as, for example, graphical indicators (i.e., fixed or animated icons), lights, colors, text, images, combinations of the foregoing, and the like. The HMI 212 includes a suitable display mechanism for displaying the visual output, such as, for example, on an electronic display (for example, a touch screen, or other suitable mechanisms). The display is a suitable display (e.g., a liquid crystal display (LCD) touch screen, an organic light-emitting diode (OLED) touch screen, and the like). In some instances, the HMI 212 displays a graphical user interface (GUI) (for example, generated by the electronic controller 102 and presented on the display) that enables a user to interact with one or more systems (and components thereof) the system 100. The HMI 212 may also provide audio output to the user such as a chime, buzzer, voice output, or other suitable sound through a speaker included in the HMI 212 or separate from the HMI 212. In some instances, HMI 212 provides a combination of visual, audio, and haptic outputs. In some examples, the HMI 212 is implemented on a separate electronic device of a user. The electronic device may be any kind of computing device such as a laptop, tablet, or a smart phone.

The location engine module 210, stored within the memory 204 and implemented by the electronic processor 202, may include one or more applications to learn information relating to a working area of the system 100 (i.e., the facility). In some embodiments, the location engine module 210 receives information from one or more of the active tracking communications device 104A and the passive tracking communications device 104B. The location engine module 210 may be implemented using, for example, a neural network processor to train based on the data received from the various devices described herein (for example, as explained in more detail below, from one or more of the active tracking communications device 104A). The location engine module 210 may be provided by a cloud services provider and may include third party provided functions and applications. The location engine module 210 also stores an asset location tracking application 214. The location engine module 210 and/or the electronic processor 202 execute the asset location tracking application 214 to determine a location of an asset within the facility as further described below.

In some instances, the electronic controller 102 uses one or more machine learning methods to analyze information from the devices 104A and/or 104B to identify/predict locations of an asset within the facility (as described herein). Such methods may be performed as part of the location engine module 210. Machine learning generally refers to the ability of a computer program to learn without being explicitly programmed. In some instances, a computer program (for example, a learning engine) is configured to construct an algorithm based on inputs. Supervised learning involves presenting a computer program with example inputs and their desired outputs. The computer program is configured to learn a general rule that maps the inputs to the outputs from the training data it receives. Example machine learning engines include decision tree learning, association rule learning, artificial neural networks, classifiers, edge computing, inductive logic programming, support vector machines, clustering, Bayesian networks, reinforcement learning, representation learning, similarity and metric learning, sparse dictionary learning, and genetic algorithms. Using these approaches, a computer program can ingest, parse, and understand data and progressively refine algorithms for data analytics.

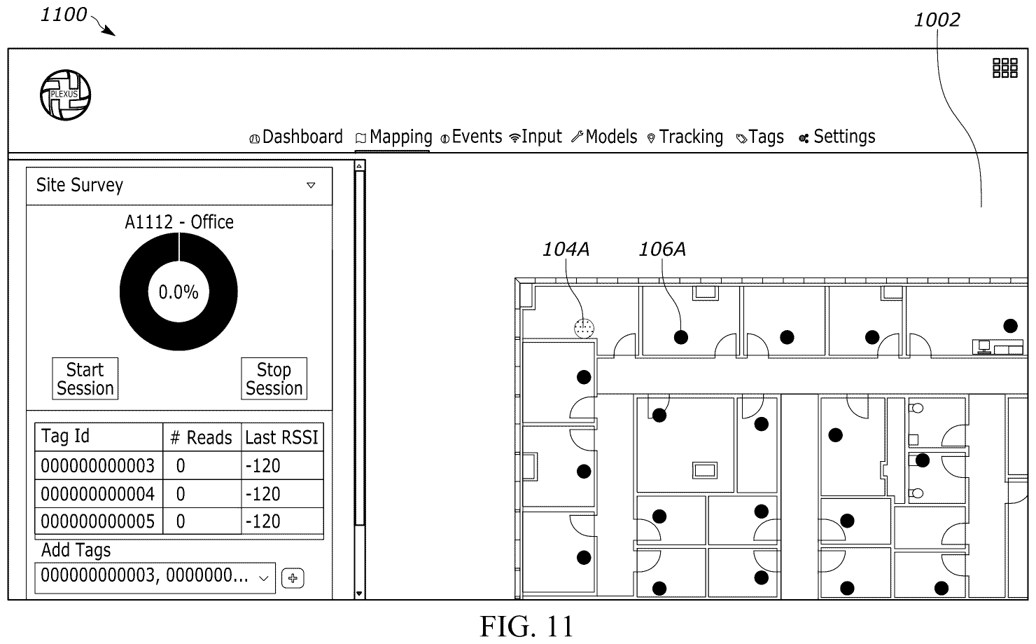

In some embodiments, the application 214 of the electronic controller 102 may be part of a computing environment operable to provide users of the system 100 with the application 214 and other computing services (for example, via a GUI implemented at the HMI 212 as described in more detail below with respect to FIGS. 11-14) implemented at least partially at the electronic controller 102. In some embodiments, the computing environment is operated for or by an enterprise and may securely provide, for example, applications for asset location tracking. In some embodiments, the computing environment is operated by an enterprise to provide various business-related software applications and services to hundreds or thousands of employees in a secure manner. In some embodiments, some of all of the computing environment is operated for a contracting agency or enterprise by a service provider and contains dedicated software environments (for example, virtual servers), which are secured from one another and accessible only by their respective authorized groups of users. In some embodiments, the computing environment may include multiple software environments for serving tens, hundreds, or thousands of users across multiple agencies, enterprises, or both. In some embodiments, the computing environment includes components in multiple geographically-distributed data centers.

The computing environment includes client computing devices, which access one or more of the application 214, provided by on one or more serving computing devices (for example, the electronic controller 102, in some embodiments). Users may access the application 214 (and other services of the computing environment) via client devices from within the computing environment, from outside the computing environment (for example, using a VPN or other encrypted session), or both. Client computing devices include personal computers, portable communication devices (for example, a mobile phone or a tablet), or other electronic computing devices that can transmit and receive data to and from the computing environment. The computing environment may interconnect its computing devices via many different types of networks, such as, for example, those described above with respect to the communications network 110, to facilitate communication between the devices of the computing environment.

In the example illustrated in FIG. 2, a single device is illustrated as including all components and the applications of the electronic controller 102. However, it should be understood that one or more of the components and one or more of the applications may be combined or divided into separate software, firmware, and/or hardware. Regardless of how they are combined or divided, these components and applications may be executed on the same computing device or may be distributed among different computing devices connected by one or more networks or other suitable communication means. In one example, all the components and applications of the electronic controller 102 are implemented in a cloud infrastructure accessible through several terminal devices, with the processor power located at a server location.

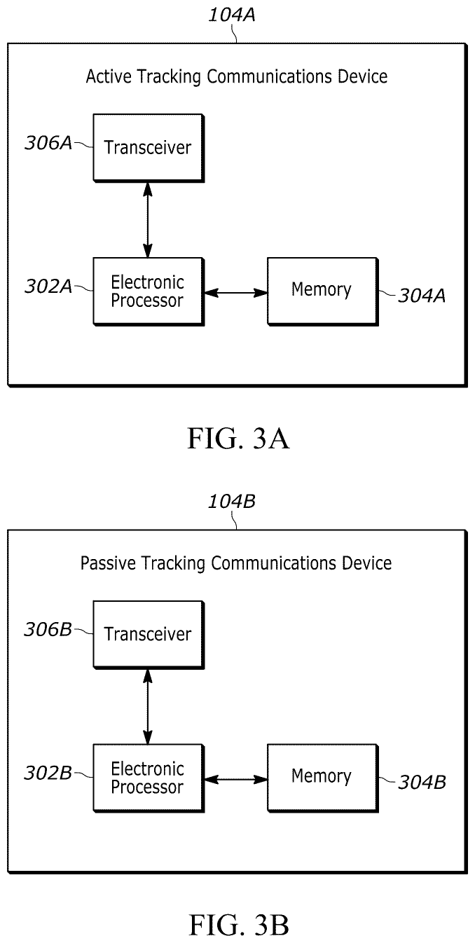

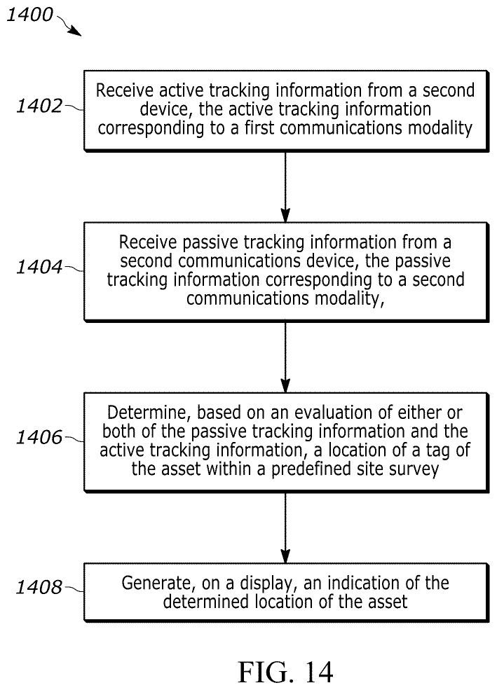

FIG. 3A is a schematic block diagram illustrating the active tracking communications device 104A, in accordance with some embodiments. As illustrated, the communications device 104A includes an electronic processor 302A, a memory 304A, and a transceiver 306A. The processor 302A, the memory 304A, and the transceiver 306A include similar components and operate similar to the electronic processor 202, the memory 204, and the transceiver 206 of the electronic controller 102, respectively, and therefore, for sake of brevity, are not explicitly described herein. However, it should be noted that the electronic processor 302A, in combination with the memory 304A and the transceiver 306A, may be configured to implement at least a portion of the methods and functionality of the electronic controller 102 in some embodiments (e.g., as described in regard to FIG. 14 below). The illustrated components, along with other various modules and components are coupled to each other by or through one or more control or data buses that enable communication therebetween. In some embodiments, the device 104A includes fewer or additional components in configurations different from that illustrated in FIG. 3A and described herein.

FIG. 3B is a schematic block diagram illustrating the passive tracking communications device 104B, in accordance with some embodiments. As illustrated, the communications device 104B includes an electronic processor 302B, a memory 304B, and a transceiver 306B. The processor 302B, the memory 304B, and the transceiver 306B include similar components and operate similar to the electronic processor 202, the memory 204, and the transceiver 206 of the electronic controller 102, respectively, and therefore, for sake of brevity, are not explicitly described herein. However, it should be noted that the electronic processor 302B, in combination with the memory 304B and the transceiver 306B, may be configured to implement at least a portion of the methods and functionality of the electronic controller 102 in some embodiments (e.g., as described in regard to FIG. 14 below). The illustrated components, along with other various modules and components are coupled to each other by or through one or more control or data buses that enable communication therebetween. In some embodiments, the device 104B includes fewer or additional components in configurations different from that illustrated in FIG. 3B and described herein.

The electronic controller 102, is configured to determine/predict a location of an asset based on information from a tag (either of tags 106A, 106B) corresponding to the asset within a facility. The electronic controller 102 determines, from information received from one or more of a respective tracking communications device of a particular modality (for example, either of a passive tracking communications modality or an active tracking communications modality), a reading of the particular tag of the asset performed by a respective tracking communications device. A received signal strength of the reading of the asset performed by a respective tracking communications device is included within the information received at the electronic controller 102. Based on one or more of a received signal strength of a reading performed by one or more of a plurality of tracking communications devices of a common tracking modality, the electronic controller 102, utilizing a location engine module (location engine module 210 of FIG. 2, as explained in more detail below), is configured to determine/predict a current location of the particular asset with reference to a predetermined site survey map (also described in more detail below). The determined location of the asset may be a stagnant position of the asset/tag or, in some embodiments, a movement of the asset (for example, in instances where the asset is being carried or handled by a user or vehicle).

As explained in more detail below, the electronic controller 102, with the location engine module 210, utilizes one or more of a predetermined site survey map in determining the location of the asset with the detected tag. The electronic controller 102, in particular, evaluates one of more of a received signal strength pattern of a single tag received from one or more respective tracking communications devices of a common modality. The electronic controller 102, using the location engine module 210, evaluates the pattern of the received signal strength (and, in some embodiments, the location of the related tracking communications devices at which the respective signal strength indicators were received) compared to one or more of a predetermined site survey map (and related data thereof) to determine the location of the asset. As explained in more detail below, the electronic controller 102 may also be configured to define one or more of a predetermined site survey map used in the evaluation performed via the location engine module 210 of the controller 102.

The electronic controller 102 is accordingly configured to track assets using one or more of an active tracking communications device (for example, the device 104A) and other assets using one or more of a passive tracking communications device (for example, the device 104B).

Referring to FIG. 4, the location engine module 210 includes, among other things, an input layer 402, a prediction pipeline 404, a tracking output 406, an embedded database 408, a computer environment application 410, and a model application programming interface (API) manager 412. The input layer 402 is a robust adapter for network devices that enables the multi-modal integration capability of the location engine module 210. Input from disparate technologies (for example, from one or more of the devices 104A and 104B is translated into a common data type including a tag identifier, a signal strength of a read of a tag 106A, 106B by a device 104A, 104B, and other related data that can be processed by the electronic controller 102. This allows the location engine module 210 to process data from RTLS (for example, WiFi™) and RFID devices (for example, the active tracking communications device 104A and the passive tracking communications device 104B, respectively). This also may simplify integration with other technologies that may be later added to the system 100 (for example, Bluetooth™).

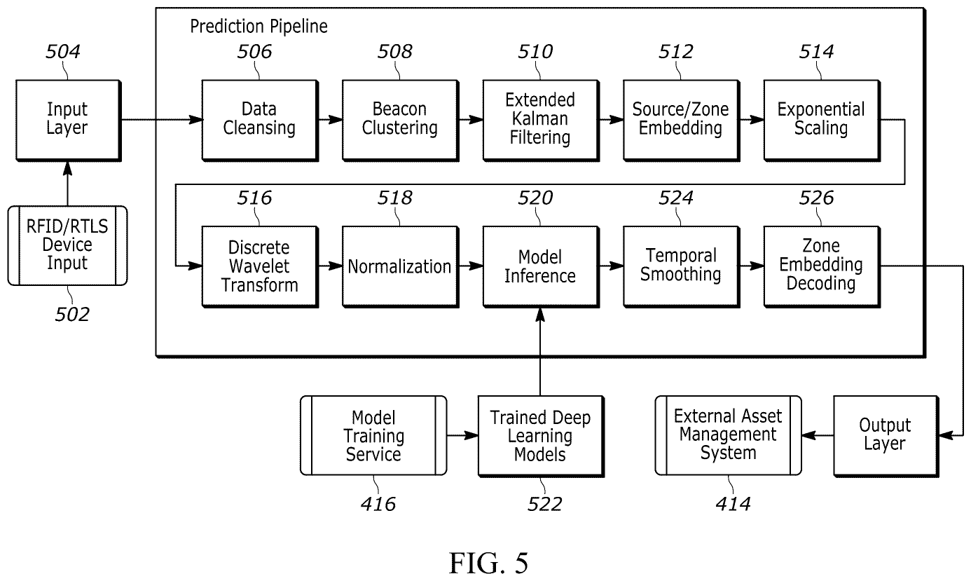

The prediction pipeline 404, described in more detail below with respect to FIG. 5, utilizes advanced pre-processing algorithms and deep learning models to predict/determine a location of an asset.

The computer environment application 410 and the model API manager 412 provide, through a computing environment (for example, as described above with respect to the asset location tracking application 214 of FIG. 2), robust software tools to users (for example, system administrators) for data collection (surveying), system oversight, and testing of the system 100 via one or more connected system devices 417.

The tracking output 406 is an adapter that allows output from the location engine module 210 to easily integrate with external asset management systems (for example, third-party asset management system 414, which may include a third-party database 415). There are multiple options for output (for example, gRPC, direct database insert, and the like).

A model training service 416, explained in more detail below, is used to train deep learning models used by the location engine module 210 on data collected through one or more administrator applications. The model API manager 412 is configured to provide information from the web application 410 to the model training service 416. In some embodiments, the model training service 416 is integrated into the location engine 210. Some or all of the functionality of the model training service 416 described herein may be performed by the electronic controller 102 (in particular, the electronic processor 202) in some embodiments.

The web application 410 includes a connected device or management user interface console 417 and an API 418 for querying the location engine module 210 about its internal state, which may allow for easy integration with external software systems for future expansions of the system 100.

In the illustrated embodiment, the computer environment application 410 is

configured to access a database 408 of the location engine module 210 and site survey data 420. The database 408 may be partially implemented on the memory 204 (FIG. 2) of the electronic controller 102, the database 108 (FIG. 1), or some combination thereof. The database 408 may store site survey data 420 collected by users to create or improve location models (described in more detail below). In some embodiments, the database 408 is configured to store site-level location data including descriptions of and relationships between zones, floors, maps, and buildings. The database 408 may be configured to store historic data of the tracking produced by the system 100. In some embodiments, the database 408 is further configured to store connection information for communicating with external systems, such as connection data for one or more of the tracking communication devices 104A, 104B or for output to one or more external asset management systems.

The site survey data 420 includes information regarding a physical layout and corresponding surfaces and storage areas (for example, walls, shelves, furniture, cabinets, etc.) (referred to herein as a site topology) of a particular facility. As explained in more detail below, the system 100 is configured to create a site survey map (alternatively referred to herein as a “site survey”) based on information received from a plurality of active tracking communications devices 104A, a plurality of passive tracking communications devices 104B, or both.

FIG. 5 is a block diagram of the prediction pipeline 404 of the location engine module 210 in accordance with some embodiments. FIG. 5 illustrates high-level steps in the prediction pipeline 404 and how input data from the network devices of the system 100 (for example, devices 104A, 104B) are processed, fed into the deep-learning model (for example, at block 502), smoothed, and passed to external asset management systems.

The RTLS/RFID Device Input (block 502) represents external input sources such as WiFi controllers or RFID devices (for examples, the active tracking communications device 104A and the passive tracking communications device 104B).

The Input Layer (block 504) is an adapter layer that aggregates read data from all source devices (of block 502) into a single input stream with a standard format, where each read includes, for example, the unique tag identifier, the source identifier (which indicates whether the particular source device is a passive or active tracking technology such as, for example, an RFID antenna or a WiFi access point), and the signal strength of the read. In some embodiments, other data is present in the read data such as, for example, battery information, transmission power, and phase-angle measurements. Such information may also be included in the single input stream output from the Input Layer.

Within the prediction pipeline 404, the information stream output from the Input Layer is provided to the Data Cleansing (block 506). This initial step in the prediction pipeline 404 removes outlier reads and filters for potentially erroneous measurements.

Each read that enters the positioning pipeline 404 represents a single measurement of a tag's (for example, the tag 106A and/or the tag 106B) signal strength with respect to a single input source (e.g., the respective tracking communications device 104A, 104B) (i.e., a received signal strength indication or RSSI). At Beacon Clustering stage (block 508), the algorithm collects all reads from all receiving sources for a given tag across a sliding window into a beacon. For example, if a single tag 106A or 106B is positioned in the middle of an overlapping range of three readers (for example, three of either of the active tracking communications device or the passive tracking communications device 104B), each reader reading at a rate of, for example, 100 reads per second. Therefore, after one second, there will be 100 reads from each reader for the tag. These 300 reads, collected across all the receiving readers, constitute the beacon.

The Kalman Filtering (block 510) is an initial step in a feature engineering phase. Inside the beacon, there may be many reads for each source device (e.g., the respective tracking communications device 104A, 104B), each including noise from environmental interference and measurement errors. The Kalman filter (or one of several related algorithms such as mean filtering and energy-based filters, one or more of which may be implemented in the location engine 215 and can be used interchangeably for different scenarios in some embodiments) takes the samples from the beacon for each source device 104A, 104B and generates a single estimate of the signal strength value over the sliding window. For example, referring to the previous example, each of the three sources have 100 reads within the beacon; after the filtering step at block 510, there will only be one representative value for each source device 104A, 104B.

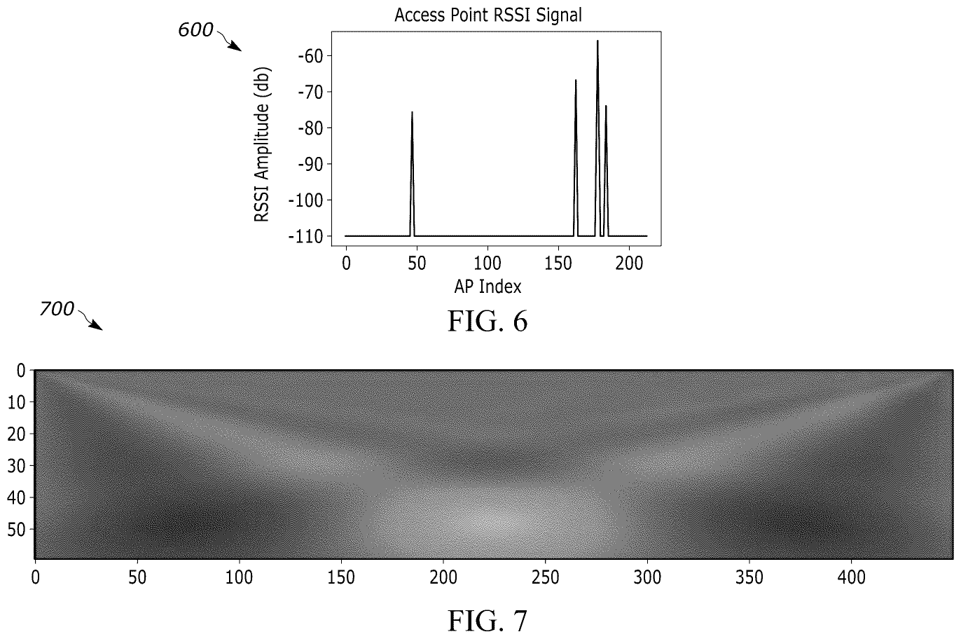

At Source/Zone Encoding (block 512), a standard data structure from the input is built that is suitable for processing inside the positioning pipeline 404. Each input source (each active tracking communications device 104A or passive tracking communications device 104B connected to the system 100) is assigned an index. The beacon data may then be encoded, for example, as a vector constructed as follows. If a source device received a tag read over the sliding window (i.e., if the source is in the beacon) then the entry at the index corresponding with the source is assigned the filtered value from the filtering step. All indices for non-receiving sources are assigned a special non-detection value, determined by the type of filter being applied. FIG. 6 illustrates an example of an encoding 600 for an active tracking beacon in accordance to some embodiments. The vector may correspond to an actual movement of an asset including the particular tag or to a position within the facility relative to the site survey. Other methods for encoding the beacon data may also be used to improve location accuracy, for instance, mathematical graph-based encodings.

Returning to FIG. 5, at Exponential Scaling (block 514), signal strength data is transformed to be linear.

The Discrete Wavelet Transform (block 516) is related to the Fourier transform in that it is used to decompose signals. It does this by convolving a special function called a wavelet for various scales and translations over the input signal from the previous step. This creates a 2-dimensional time-frequency representation of the signal called a scalogram. FIG. 7 illustrates an example of a scalogram 700. This technique is applied when the beacon data has been encoded following the vector method described above. In embodiments where other encoding methods are applied to encode the beacon data (block 512 above), related but different feature transformations than the Discrete Wavelet Transform may be applied.

Returning to FIG. 5, at Normalization (block 518), as part of pre-processing for the deep learning algorithms the input is scaled to a standardized range.

At Model Inference (block 520), the normalized encoded beacon representation is fed into the pre-trained model (trained on the site survey data 420 of FIG. 4). The model outputs a vector of probabilities, where each entry in the vector designates the estimated probability that the tag is at the location corresponding to that index. Models 522 provided to the Model Inference at block 520 are trained by the Model Training Service 416, which is described in more detail below.

At Temporal Smoothing (block 524), the output of the model of block 520, because it is only a function of the measurements in the beacon, and therefore does not account for any knowledge of historical movement of the tag or patterns of movement at certain locations, the temporal filtering stage at block 524 takes the estimated location from the model and combines it with previous location estimates for the tag 106A, 106B to modulate the predictions. Techniques utilized at block 524 may include one or more of a Bayesian update algorithm, Hidden Markov modeling, and Kalman filtering (here applied to the model output rather than the raw input from the devices 104A, 104B).

At Decoding (block 526), after the temporal smoothing at block 524 is applied, the output is transformed into a format suitable for processing by other systems of the system 100. The data includes, for example, the tag identifier and the predicted location.

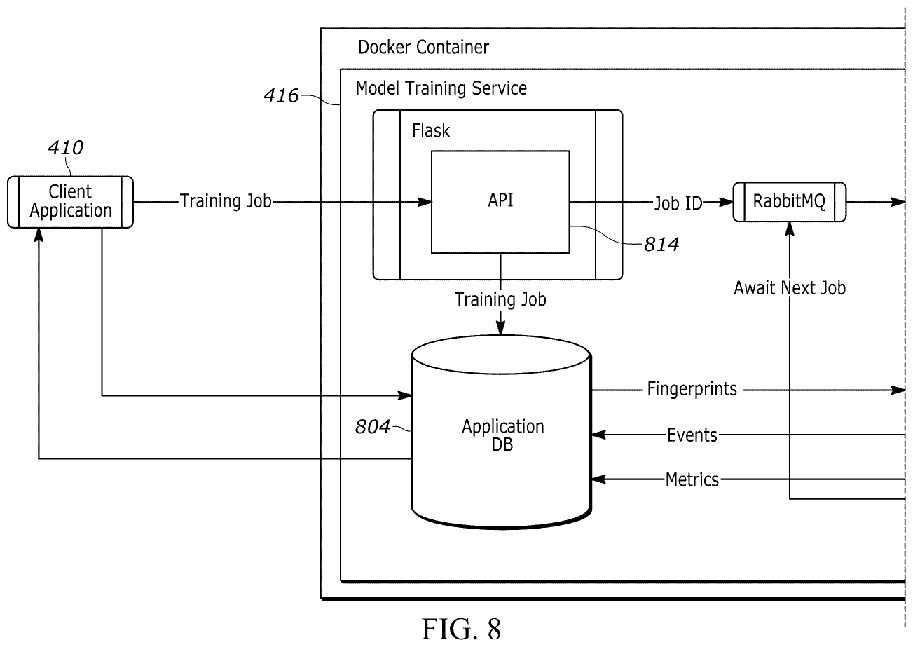

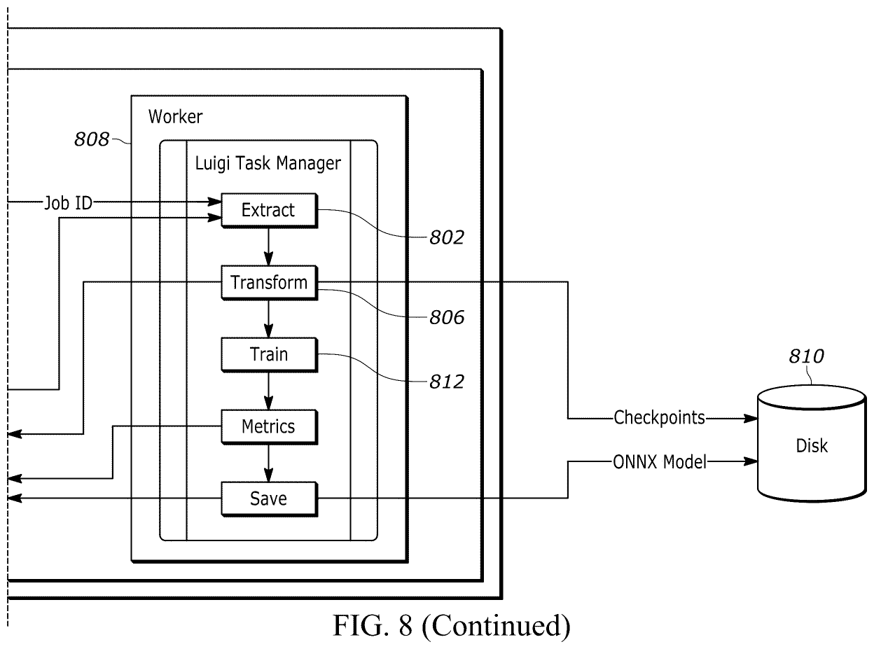

FIG. 8 is a block diagram illustrating the model training service 416 in accordance with some embodiments. The model training service 416 automates the creation of deep learning models used in the prediction pipeline 404. It enables system administrators to easily train the location engine 215 on data collected for new customers during initial site survey creation (described in more detail below) and to fine-tune models for existing customers. For researchers, it may enable rapid execution of experiments comparing different hyperparameter values, pre-processing implementations, and model architectures to improve the existing implementation as well as test potential future business scenarios.

After a site survey (described in more detail below), a user uses the computer environment application 410 (FIG. 4) to send a training job to the model training service 416. The model training service 416 sends back a model (for example, model 522 of FIG. 5) trained on the site survey data 420 which can be used in the prediction pipeline 404. The model training service 416 may also report the quality/skill of the particular model for evaluation. The model training service 416 is, in some embodiments, an Extract, Transform, Load (ETL) pipeline. First, the model training service 416 extracts the site survey data, then transforms it according to the previously described pipeline, then loads the resulting data representations (for example, scalogram 700 of FIG. 7) for training. The training stage learns a relationship between the beacon data representations from the site survey data and the locations from which the data were collected.

For relatively larger sites (for example, hospital campuses with multiple buildings), these site surveys might be quite large. In such instances, in some embodiments, the model training service 416 is implemented separate from the location engine module 210 (for example, to reduce a computational load of the engine module 210).

As illustrated, data (block 802) is read from a database 804 specified in the job, corresponding with the site survey data 420 (FIG. 4) collected for the current site of a facility. Transformations (block 806) take place inside a worker service 808 in a task and dependency management system 810. The system 810 handles shared dependencies internally using a task/dependency graph (not shown). For example, in some embodiments, if two consecutive jobs are received that both make use of the same database 804, the first job will perform the extract step at block 802 from the database 804 and save the resulting dataframe out as a dependency to the file system as a checkpoint with a specific hash in the file name indicating the database the dependency was created for. The next job can then make use of this dependency rather than re-running the same operation again. Each transformation step (block 806) may be encapsulated in a task. Each task may require one or more dependencies from other tasks and may additionally create a dependency that other tasks require.

In some embodiments, each task creates a dependency. These dependencies, once created, are saved to a physical file system 810 as checkpoints with the file name containing a hash specific to the parameters of that dependency for re-use. They are saved to the archive folder in the directory in which the service is installed.

Training (block 812) is initiated on the model specified in the job using the data produced by the ETL pipeline. Several of the training hyperparameters can be configured through an API 814. The API 814 may be, in some embodiments, external to the model training service 416. In some embodiments the API 814 is at least partially incorporated into either or both of the API 418 and the model API manager 412 (FIG. 4).

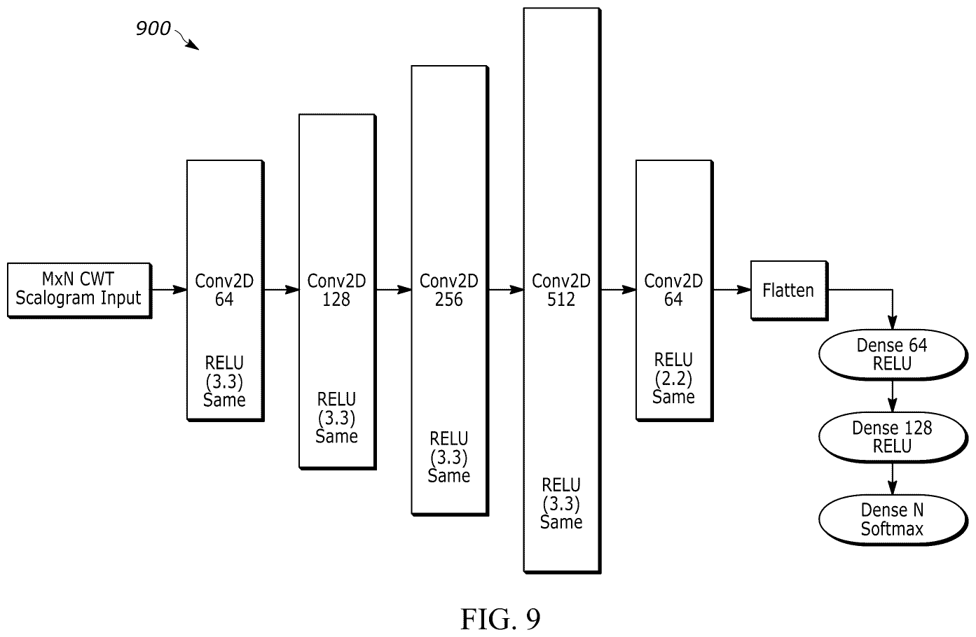

The models created by the model training service 416 and used by the prediction pipeline 404 to infer the location of unknown assets are a form of deep learning models (for example, CNNs). The CNNs may be built using any number of architectures, where the architecture describes the specific layers of the model and their arrangement, along with other technical details such as the choice of activation function for each layer and the number of neurons in each. FIG. 9 illustrates an example of a model architecture 900 in accordance with some embodiments.

FIG. 9 shows one example of an architecture 900 for the deep learning model of the location engine module 210. A typical CNN involves multiple layers each feeding into the next and outputs a vector of probabilities where each entry in the vector corresponds with the probability that the input belongs to that class. The specific combination of layers and hyperparameters for each layer are what define the architecture. Different architectures may perform better on some problems than others. CNNs are trained on historical data to learn relationships between the inputs and outputs. For the location engine module 210, the inputs may be normalized scalograms (from blocks 516 and 518 in the pipeline 404 described above with respect to FIG. 5), or other, related representations. The output of the model corresponds with the various possible locations of the tag 106A or 106B that produced the beacon that became the representation input for the model. As the vector-based encoding method described previously produces image-like representations, the CNN, which is typically applied to image classification problems, may be an effective classifier.

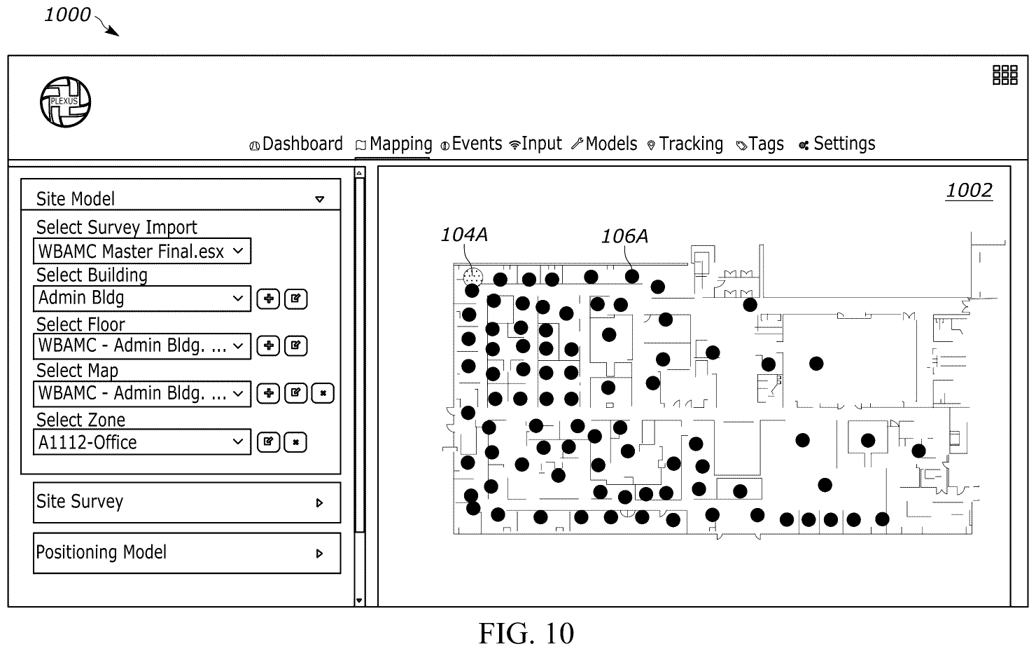

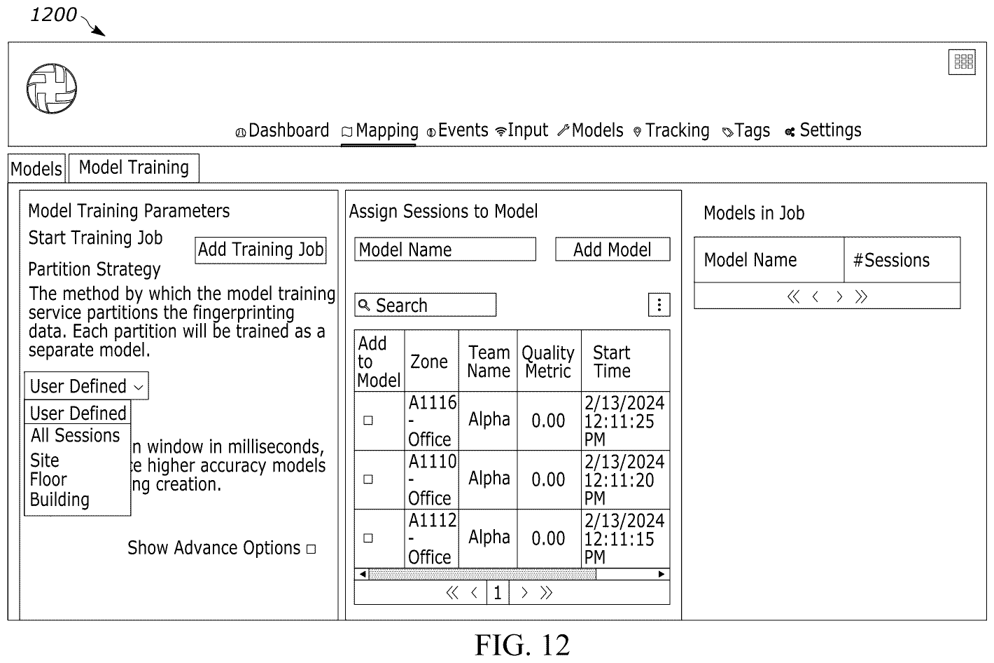

FIGS. 10-13, each illustrate a respective GUI generated by the electronic controller 102 (for example, as part of the computer environment described above) in accordance with some embodiments. As illustrated in GUI 1000 of FIG. 10, client maps 1002 are labeled with the individual zones/locations. The map 1002 in the illustrated example corresponds to a full-scale RTLS deployment for a hospital facility including an active tracking communications device 104A and a plurality of active tracking tags 106A. Passive tracking (for example, RFID) deployments may typically be smaller-scale, and the dots may be used for labeling individual desks or shelves. As illustrated in the GUI 1100 of FIG. 11, site survey data may be recorded in sessions for each location of interest within the facility. For each tag 106A and/or 106B in the site survey session, all the reads from that tag are assigned to the selected location. This can be used by the model training service 416 to produce models. Referring to GUI 1200 of FIG. 12, models may be created for all available site survey sessions or tailored to subsets of the data for experimentation. These training jobs are then sent to the model training service 416 as described above.

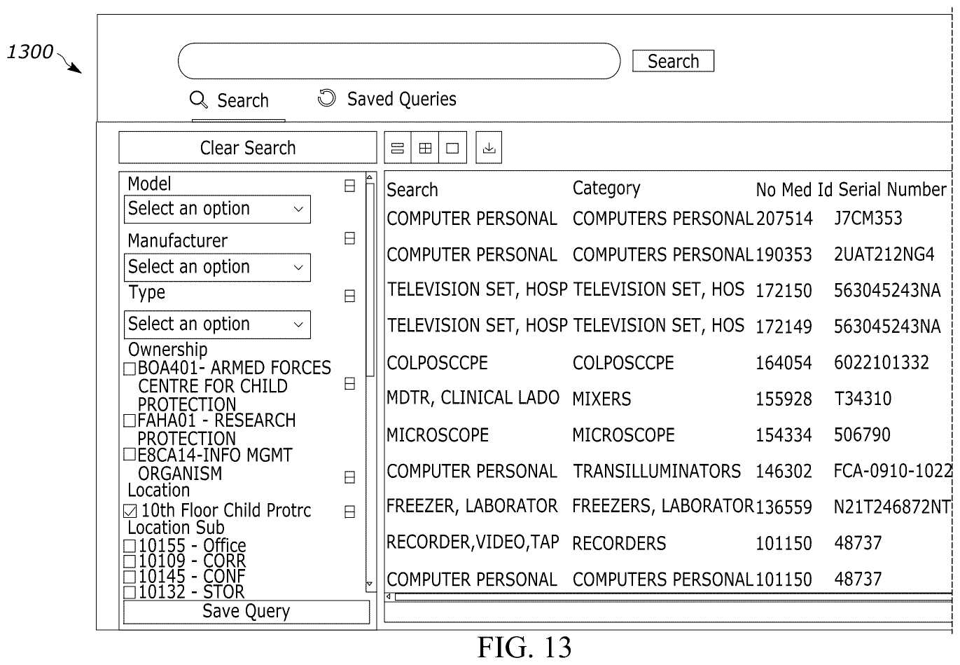

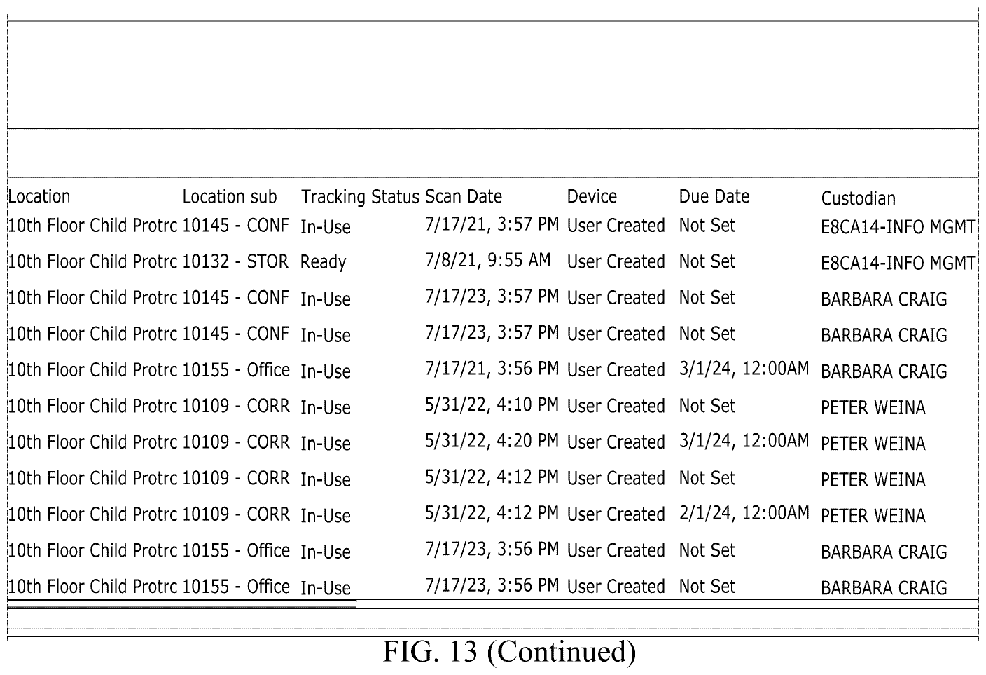

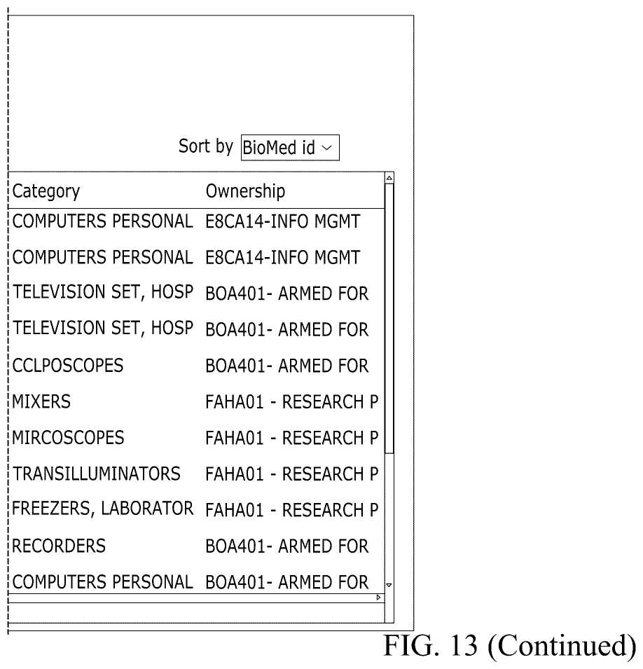

Referring to GUI 1300 of FIG. 13, once the model is trained, tracking for each tag (in the illustrated embodiment, the tags 106A) can be viewed through a live tracking feature, or through third party asset management systems (for example, system 414 of FIG. 4).

During a site survey, one or more system administrators physically transport a pre-defined set of asset tags to each zone of a physical site of a facility that is to be included in the survey. Through a GUI (for example, of the electronic controller 102), the administrator(s) define and select the zone in which the asset tags are currently physically located. All the measured data received by the controller 102 during the time in which a particular zone was selected by the administrator is assigned to that zone as a reference location. During the training phase, the relationship between all the measurements for the selected tags and each zone is learned using these manually assigned references.

In some embodiments, each of the zones defines a two-dimensional area within a facility or space (for example, a 6 foot length by 6 foot area width). In some embodiments, each of the zones defines a three-dimensional area within the facility or physical space (for example, including a height of the tag from a ground reference (for example, the floor of the space)). A three-dimensional zone may be, for example, a 30 foot length by 20 foot width by 9 foot height).

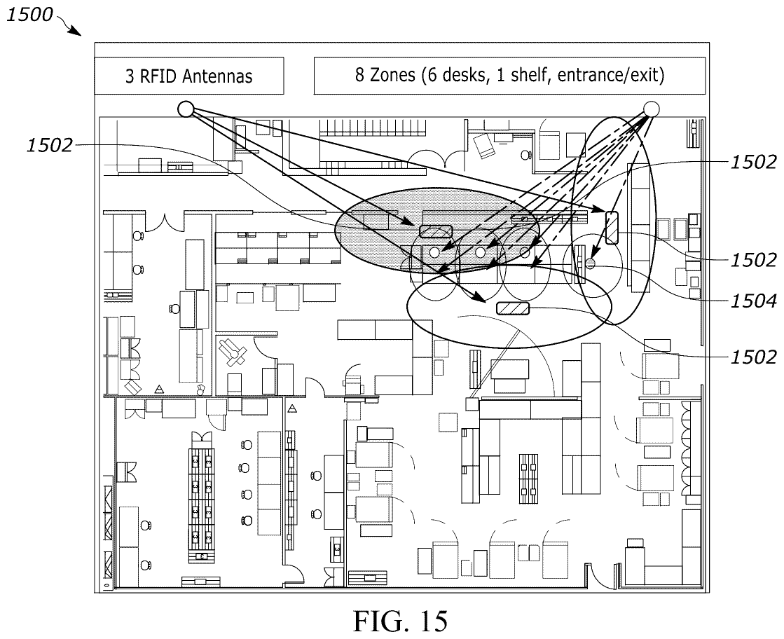

FIG. 15 illustrates a site 1500 of a facility in accordance with some embodiments. The illustrated site 1500 includes a plurality of passive tracking communications devices 1502 (for example, similar to that of the passive tracking communications device 104B of FIG. 1) and a plurality of passive tracking tags 1504 (for example, similar to that of the passive tracking tag of FIG. 1).

For ease of simplicity, the method for creation of a new site survey (for example, as performed by the electronic controller 102 and, more specifically, the electronic processor 202) is described herein in relation to the system of FIG. 15. It should be understood that, although described in terms of utilizing a passive tracking modality, the electronic controller 102 also (additionally or alternatively) may be configured to determine a site survey using active tracking communications devices (for example, similar to the active tracking communications device 104A of FIG. 1) and active tracking tags (for example, similar to the active tracking tag 106A of FIG. 1).

Each of the tracking communications devices 1502 have a respective detectable range (referred to herein as a field of view). The communications device 1502 may be positioned relative to each other such that at least a portion of their respective field of view overlaps with at least a portion of a field of view of another communications device 1502. The electronic controller 102 is configured to define a plurality of zones corresponding to a physical area of the site of the facility including at least a portion of a field of view of at least one tracking communications device 1502.

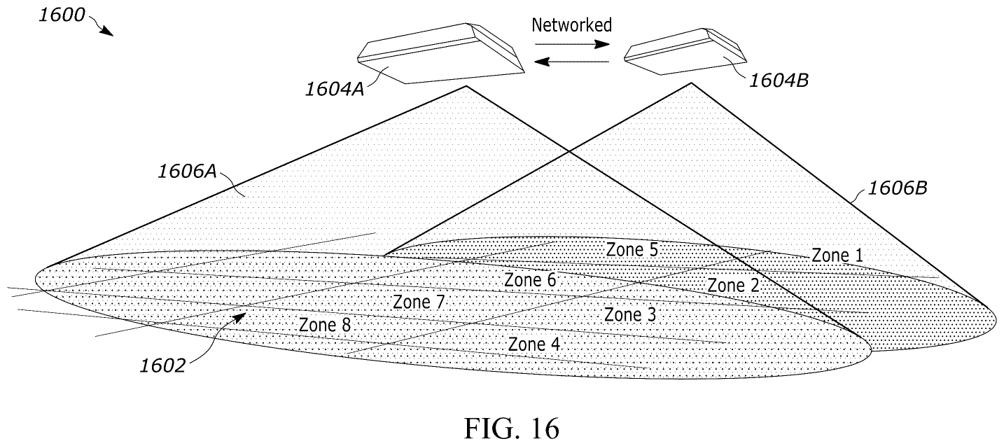

For example, FIG. 16 illustrates a plurality of zones 1602 defined for a site in accordance with some embodiments. As illustrated, a first tracking communications device 1604A and a second tracking communications device 1604B (each including a respective field of view 1606A and 1606B) are positioned such that at least a portion of their respective field of views 1606A, 1606B overlap with each other. In the illustrated example, both devices 1606A and 1606B are RFID devices.

At least one of the tags 1504 is positioned within each defined zone. A user then assigns (for example, via the HMI 212) a location to each tag 1504, the location for each tag 1504 corresponding to an actual physical location of the tag 1504 (for example, the zone defined by the electronic controller 102). In some embodiments, the location may include more particular location information. The defined location, in some embodiments, may include a location in space (for example, on a particular shelf of a bookcase or in a specific drawer of a desk). In some embodiments, the location includes a height from the ground.

The electronic controller 102 then collects read information from all of the communications devices 1502 over a predetermined time period. A resulting received signal strength for each read of each of the tags 1504 is determined. The received signal strength for each tag 1504 and the physical location of the corresponding tag 1504 as assigned by the user is then used to produce a site survey map. The resulting site survey map is then utilized to train the one or more prediction models described above.

Traditionally, particularly in passive tracking systems such as RFID, receiving tracking communications devices may purposefully be positioned such that their respective field of views do not overlap as scans performed by neighboring tracking communications devices may negatively impact scans performed at a single tracking communications device (for example, RF interference) and result in a failure to read a tag. With reference to the example illustrated in FIG. 16, overlapping of the field of views allows for more precise detections and fewer “dead” or out of range zones. Traditional passive tracking approaches rely on a static assignment of a location to each receiver, meaning any tag in the field of view of a given device will be assigned the location associated with the receiver. If the field of view overlaps between multiple devices, the location assignments will conflict, resulting in “bounces.” In contrast, the overlapping ranges are enabled for use with the system described herein through the use of a more sophisticated algorithm, specifically the deep learning model and pipeline described above, which learns a relationship between the measurements collected by all the receivers whose field of view includes the target zone. Rather than a static assignment, the deep learning algorithm leverages the measured data (for example, the signal strength) from all the receivers to infer the location of the target asset tag following a probabilistic model that compares the measurements at the receivers from the training data to the current measurements being received for tags at unknown locations.

The controller 102 utilizes received signal strength (for example, RSSI) data associated with tags received from either or both devices 1606A and 1606B, runs this data through a sophisticated location prediction algorithm (for example, described above with respect to FIGS. 4 and 5, and produces tracking information (location, status, and time) for the assets labeled with tags moving into a designated location zone.

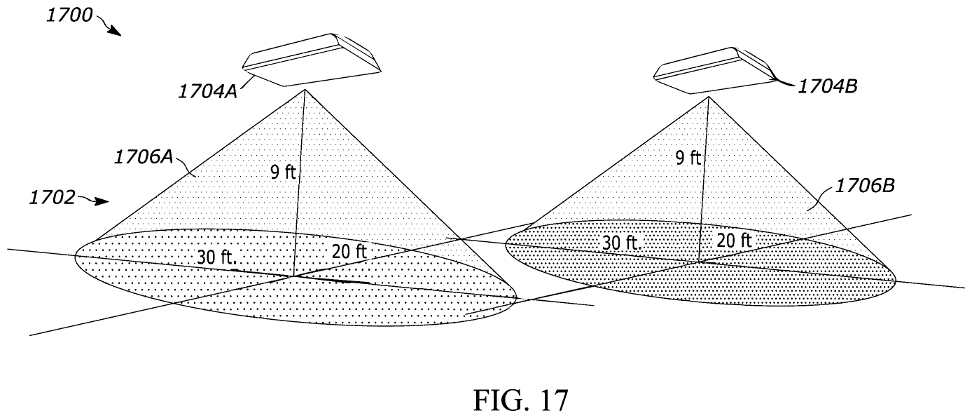

The position/topology of the tracking communication devices relative to each other may include overlapping field of views, separate field of views, or some combination thereof (for example, as shown in FIG. 15). FIG. 17 illustrates a plurality of zones 1702 defined for a site in accordance with some embodiments. As illustrated, a first tracking communications device 1704A and a second tracking communications device 1704B (each including a respective field of view 1706A and 1706B) are positioned such that at least a portion of their respective field of views 1706A, 1706B do not overlap with each other. In the illustrated example, both devices 1706A and 1706B are RFID devices.

Positioning the tracking communication devices such that their fields of view do not overlap may be advantageous for indoor use for precise indoor asset tracking. The tracking communication devices may be positioned at narrow communication choke points and in high density storage environments. In such implementations, locations and sub-locations are associated to each respective device, rather than a received signal strength signature.

In contrast, positioning the tracking communication devices such that their fields of view overlap (for example, FIG. 16) may be beneficial in open space, high-traffic environments. The tracking communication devices may be configured as a collective or group hive network. Location zones are defined and calibrated for received signal strength signature. A tag location is determined by signal signature and then assigned to the corresponding zone. In some embodiments, the zone is a 6 foot by 6 foot area.

FIG. 14 is a flowchart illustrating an example method 1400 for tracking a location of an asset within a facility in accordance with some embodiments. As an example, the method 1400 is explained in terms of the electronic controller 102, in particular the electronic processor 202. However, portions of the method 1400 may be distributed among multiple devices (e.g., one or more additional controllers/processors of or connected to the system 100) and applied to more than one asset including a tag (or type thereof) at the same or at different times.

At block 1402, the electronic processor 202 receives active tracking information from a first communications device (for example, the active tracking communications device 104A), the active tracking information corresponding to a first communications modality. The information corresponds to at least one of an active tracking tag 106A. At block 1404, the electronic processor 202 receives passive tracking information from a second communications device (for example, the passive tracking communications device 104B), the passive tracking information corresponding to a second communications modality. The information corresponds to at least one of a passive tracking tag 106B.

At block 1406, the electronic processor 202 determines, based on the evaluation of either or both of the passive tracking information and the active tracking information, a location of a tag of the asset within a predefined site survey map and, at block 1408, generates, on a display (for example, of the HMI 212), an indication of the determined location of the asset.

In the foregoing specification, specific examples, aspects, and features have been described. However, one of ordinary skill in the art appreciates that various modifications and changes can be made without departing from the scope of the aspects, examples, and features as set forth in the claims below. Accordingly, the specification and figures are to be regarded in an illustrative rather than a restrictive sense, and all such modifications are intended to be included within the scope of present teachings.

In some embodiments, the techniques described herein relate to an asset tracking system for tracking a location of an asset within a facility. The system includes an electronic processor configured to receive active tracking information from a first communications device, the active tracking information corresponding to a first communications modality, receive passive tracking information from a second communications device, the passive tracking information corresponding to a second communications modality, and determine, based on the evaluation of either or both of the passive tracking information and the active tracking information, a location of a tag of the asset within a predefined site survey. The electronic controller is further configured to generate, on a display, an indication of the determined location of the asset.

In some embodiments, the techniques described herein relate to an asset tracking system for tracking a location of an asset within a facility. The system includes an electronic processor configured to receive, from an active tracking communications device, active tracking information regarding at least one of an active tracking tag, the active tracking information including an identifier corresponding to the active tracking tag and a received signal strength of the active tracking information of the active tracking tag received at the active tracking communications device. The electronic processor is further configured to determine, based on the received active tracking information, an active tracking site survey, the site survey corresponding to a physical layout of an area of the facility, receive, from a passive tracking communications device, passive tracking information regarding at least one of a passive tracking tag, the passive tracking information including an identifier corresponding to the passive tracking information tag and a received signal strength of the passive tracking information of the passive tracking tag received at the passive tracking communications device, determine, based on the passive tracking information, a passive tracking site survey, the passive tracking site survey corresponding to a physical layout of a second area of the facility, and train location models using either or both of the active tracking survey site and passive tracking survey site. The electronic processor is further configured to receive, from a tracking communications device, tracking information regarding a tracking tag of the asset, the tracking information including an identifier of the tracking tag of the asset and a received signal strength of the tracking information received at the tracking communications device from the tracking tag, determine, using the location engine, the location of the asset based on the tracking information, and generate, on a display, an indication of the determined location of the asset. In some embodiments, the active tracking tag is a real-time location system (RTLS) tag and the passive tracking tag is a radio frequency identification (RFID) tag and wherein the tracking tag is either a RTLS tag or a RFID tag.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The following paragraphs provide various examples and alternative of the embodiments described herein.

Example 1. An asset tracking system for tracking a location of an asset within a facility, the system comprising: an electronic processor configured to receive, from an active tracking communications device, active tracking information of at least one of an active tracking tag, the active tracking information including an identifier corresponding to the active tracking tag and a received signal strength of the active tracking information of the active tracking tag received at the active tracking communications device, determine, based on the received active tracking information, an active tracking site survey, the site survey corresponding to a physical layout of a first area of the facility, receive, from a passive tracking communications device, passive tracking information of at least one of a passive tracking tag, the passive tracking information including an identifier corresponding to the passive tracking information tag and a received signal strength of the passive tracking information of the passive tracking tag received at the passive tracking communications device, determine, based on the passive tracking information, a passive tracking site survey, the passive tracking site survey corresponding to a physical layout of a second area of the facility, train a location engine using the active tracking site survey and passive tracking site survey, generate, via the location engine, the predetermined site survey based on the active tracking site survey and the passive tracking site survey, receive, from an electronic communications device, tracking information regarding a tracking tag of the asset, the tracking information including an identifier of the tracking tag of the asset and a received signal strength of the tracking information received at the tracking communications device from the tracking tag of the asset, determine, using the location engine, the location of the asset based on the tracking information, and generate, on a display, an indication of the determined location of the asset.

Example 2. The system of example 1, wherein the active tracking tag is a real-time location system (RTLS) tag and the passive tracking tag is a radio frequency identification (RFID) tag and wherein the tracking tag of the asset is either a RTLS tag or a RFID tag.

Example 3. The system of example 1, wherein determining the location further includes comparing the received signal strength pattern to a predetermined site survey generated by the location engine.

Example 4. The system of example 1, wherein determining the location of the asset includes determining a height of the asset from a ground reference.

Example 5. The system of example 1, wherein determining the location of the asset includes determining a location of a respective receiving tracking communications device.

Example 6. The system of example 1, wherein the electronic processor is further configured to determine, based on the either or both of the passive tracking information and the active tracking information, a movement of the asset within a predefined site survey.

Example 7. An asset tracking system for tracking a location of an asset within a facility, the system comprising: an electronic processor configured to receive active tracking information from a first communications device, the active tracking information corresponding to a first communications modality, receive passive tracking information from a second communications device, the passive tracking information corresponding to a second communications modality, determine, based on either or both of the passive tracking information and the active tracking information, a location of the asset within a predetermined site survey, and generate, on a display, an indication of the determined location of the asset.

Example 8. The system of example 7, wherein the active tracking information is from a real-time location system (RTLS) tag and the passive tracking information is from a radio frequency identification (RFID) tag.

Example 9. The system of example 7, wherein the predetermined site survey corresponds to a physical layout within the facility, the predetermined site survey being defined based on an active tracking site survey and a passive tracking site survey.

Example 10. The system of example 9, wherein the electronic processor is further configured to receive, from an active tracking communications device, first active tracking information of at least one of an active tracking tag, the first active tracking information including an identifier corresponding to the active tracking tag and a received signal strength of the first active tracking information of the active tracking tag received at the active tracking communications device, determine, based on the received first active tracking information, the active tracking site survey, the active site survey corresponding to a physical layout of a first area of the facility, receive, from a passive tracking communications device, first passive tracking information of least one of a passive tracking tag, the first passive tracking information including an identifier corresponding to the passive tracking tag and a received signal strength of the first passive tracking information of the passive tracking tag received at the passive tracking communications device, determine, based on the received first passive tracking information, the passive tracking site survey, the passive tracking site survey corresponding to a physical layout of a second area of the facility, train a location engine using the active tracking site survey and the passive tracking site survey, generate, via the location engine, the predetermined site survey based on the active tracking site survey and the passive tracking site survey.

Example 11. The system of example 10, wherein the electronic processor is

configured to, in determining the location of the asset within a predetermined site survey, determine a received signal strength pattern of the either or both of the passive tracking information and the active tracking information.

Example 12. The system of example 11, wherein determining the location of the asset includes comparing the received signal strength pattern to the predetermined site survey.

Example 13. The system of example 7, wherein determining the location of the asset includes determining a height of the asset from a ground reference.

Example 14. The system of example 7, wherein determining the location of the asset includes determining a location of a respective receiving tracking communications device.

Example 15. The system of example 7, wherein the electronic processor is further configured to determine, based on the either or both of the passive tracking information and the active tracking information, a movement of the asset within a predefined site survey.

Various features, aspects, advantages, and examples are set forth in the following claims.

What is claimed is:

1. An asset tracking system for tracking a location of an asset within a facility, the system comprising:
an electronic processor configured to
receive, from an active tracking communications device, active tracking information of at least one of an active tracking tag, the active tracking information including an identifier corresponding to the active tracking tag and a received signal strength of the active tracking information of the active tracking tag received at the active tracking communications device,
determine, based on the received active tracking information, an active tracking site survey, the site survey corresponding to a physical layout of a first area of the facility,
receive, from a passive tracking communications device, passive tracking information of at least one of a passive tracking tag, the passive tracking information including an identifier corresponding to the passive tracking information tag and a received signal strength of the passive tracking information of the passive tracking tag received at the passive tracking communications device,
determine, based on the passive tracking information, a passive tracking site survey, the passive tracking site survey corresponding to a physical layout of a second area of the facility,
train a location engine using the active tracking site survey and passive tracking site survey,
generate, via the location engine, the predetermined site survey based on the active tracking site survey and the passive tracking site survey,
receive, from an electronic communications device, tracking information regarding a tracking tag of the asset, the tracking information including an identifier of the tracking tag of the asset and a received signal strength of the tracking information received at the tracking communications device from the tracking tag of the asset,
determine, using the location engine, the location of the asset based on the tracking information, and
generate, on a display, an indication of the determined location of the asset.

2. The system of claim 1, wherein the active tracking tag is a real-time location system (RTLS) tag and the passive tracking tag is a radio frequency identification (RFID) tag and wherein the tracking tag of the asset is either a RTLS tag or a RFID tag.

3. The system of claim 1, wherein determining the location further includes comparing the received signal strength pattern to a predetermined site survey generated by the location engine.

4. The system of claim 1, wherein determining the location of the asset includes determining a height of the asset from a ground reference.

5. The system of claim 1, wherein determining the location of the asset includes determining a location of a respective receiving tracking communications device.

6. The system of claim 1, wherein the electronic processor is further configured to determine, based on the either or both of the passive tracking information and the active tracking information, a movement of the asset within a predefined site survey.

7. An asset tracking system for tracking a location of an asset within a facility, the system comprising:
an electronic processor configured to
receive active tracking information from a first communications device, the active tracking information corresponding to a first communications modality,
receive passive tracking information from a second communications device, the passive tracking information corresponding to a second communications modality,
determine, based on either or both of the passive tracking information and the active tracking information, a location of the asset within a predetermined site survey, and
generate, on a display, an indication of the determined location of the asset.

8. The system of claim 7, wherein the active tracking information is from a real-time location system (RTLS) tag and the passive tracking information is from a radio frequency identification (RFID) tag.

9. The system of claim 7, wherein the predetermined site survey corresponds to a physical layout within the facility, the predetermined site survey being defined based on an active tracking site survey and a passive tracking site survey.

10. The system of claim 9, wherein the electronic processor is further configured to
receive, from an active tracking communications device, first active tracking information of at least one of an active tracking tag, the first active tracking information including an identifier corresponding to the active tracking tag and a received signal strength of the first active tracking information of the active tracking tag received at the active tracking communications device,
determine, based on the received first active tracking information, the active tracking site survey, the active site survey corresponding to a physical layout of a first area of the facility,
receive, from a passive tracking communications device, first passive tracking information of least one of a passive tracking tag, the first passive tracking information including an identifier corresponding to the passive tracking tag and a received signal strength of the first passive tracking information of the passive tracking tag received at the passive tracking communications device,
determine, based on the received first passive tracking information, the passive tracking site survey, the passive tracking site survey corresponding to a physical layout of a second area of the facility,
train a location engine using the active tracking site survey and the passive tracking site survey,
generate, via the location engine, the predetermined site survey based on the active tracking site survey and the passive tracking site survey.

11. The system of claim 10, wherein the electronic processor is configured to, in determining the location of the asset within a predetermined site survey, determine a received signal strength pattern of the either or both of the passive tracking information and the active tracking information.

12. The system of claim 11, wherein determining the location of the asset includes comparing the received signal strength pattern to the predetermined site survey.

13. The system of claim 7, wherein determining the location of the asset includes determining a height of the asset from a ground reference.

14. The system of claim 7, wherein determining the location of the asset includes determining a location of a respective receiving tracking communications device.

15. The system of claim 7, wherein the electronic processor is further configured to determine, based on the either or both of the passive tracking information and the active tracking information, a movement of the asset within a predefined site survey.
